(19) United States
(12) Patent Application Publication
(10) Pub. No.: US 2005/0121969 A1
(43) Pub. Date: Jun. 9, 2005

(54) Lubricant for wafer polishing using a fixed abrasive pad

(76) Inventors: Ismail Emesh, Gilbert, AZ (US); Bentley J. Palmer, Phoenix, AZ (US)

Correspondence Address: INGRASSIA FISHER & LORENZ, P.C., 7150 E. CAMELBACK, STE. 325, SCOTTSDALE, AZ, 85251, US

(21) Appl. No.: 10/729,119

(22) Filed: Dec. 4, 2003

(51) Int. Cl. B60B 7/00

(52) U.S. Cl. 301/37.105

(57) ABSTRACT

A polishing fluid for a chemical-mechanical polishing process, an apparatus including the polishing fluid, and methods for making and using the polishing fluid, the fluid including a surfactant having an aliphatic structure, a buffer for maintaining the polishing fluid at a pH ranging between about 5 and about 14, and a chelating agent.

### TECHNICAL FIELD

The present invention relates to chemical-mechanical polishing devices. More particularly, the present invention relates to wafer planarization enhancement through use of an improved fixed abrasive polishing pad.

### BACKGROUND OF THE INVENTION

Chemical-mechanical polishing (CMP) is the process of removing projections and other imperfections from a semiconductor wafer or other workpiece, hereinafter generally referred to as a “wafer,” to create a smooth planar surface. CMP processes are widely used for manufacturing VLSI devices with sub-micron geometries, as the processes reduce the step height between the high and low features on the wafer surface.

Wafers provide the basic substrate material in the semiconductor industry for the manufacture of integrated circuits. Wafers are typically created by growing an elongated cylinder or boule of single crystal silicon and then slicing individual wafers from the cylinder. Slicing causes both faces of the wafer to be somewhat rough. Planarization is desirable because the front face of the wafer on which integrated circuitry is to be constructed must be substantially flat in order to facilitate reliable semiconductor junctions with subsequent layers of material applied to the wafer. Composite thin film layers comprising metals for conductors or oxides for insulators must also have a uniform thickness if they are to be joined to the semiconductor wafers or to other composite thin film layers.

Planarization is typically completed before performing lithographic processing steps that create integrated circuitry or interconnects on the wafer. Non-planar surfaces result in poor optical resolution of subsequent photolithographic processing steps which in turn hinders high-density features from being adequately printed. If a metallization step height is too large, open circuits will likely be created. Consequently, CMP tools are continually being improved upon with an aim toward controlling and improving wafer planarization.

In a conventional CMP assembly the wafer is secured in a carrier connected to a shaft. The shaft is typically connected to a transporter that moves the carrier between a load or unload station and a position adjacent to a polishing pad. One side of the polishing pad has a polishing surface thereon, and an opposite side is mounted to a rigid platen. The polishing surface is typically formed using a resinous material having a cellular structure.

During polishing, pressure is exerted on a wafer back surface by the carrier in order to press a wafer front surface against the polishing pad. Polishing fluid is introduced onto the polishing surface while the wafer and/or polishing pad are moved in relation to each other by means of motors connected to the shaft and/or platen. When pressure is applied between the polishing pad and the wafer, mechanical stresses are concentrated on the exposed edges of the adjoining cells in the polishing pad. Abrasive particles within the fluid concentrated on these edges tend to create zones of localized stress on the wafer in the vicinity of the exposed cell edges. The above combination of chemical and mechanical stress creates localized pressure on the wafer and produces mechanical strain on the chemical bonds that form the surface being polished. The strain on the wafer surface chemical bonds renders the local wafer surface portions susceptible to chemical attack or corrosion. High features on the wafer surface receive a large amount of pressure from the polishing pad, resulting in an increased removal rate in the high feature areas. Conversely, low features receive a small amount of pressure from the polishing pad, resulting in decreased removal rates in the low feature areas. The differences in removal rates across microscopic regions of the wafer surface enhance the overall wafer planarity after polishing is performed.

As the size of microelectronic structures used in integrated circuits decreases to sub-half-micron levels, the requisite degree of planarity increases. These is especially the case as the number of microelectronic structures on current and future generation integrated circuits increases, and as lithographic techniques for smaller devices require increased accuracy. A wafer is currently considered sufficiently planar when differences in step height between the high and low features on a wafer are within a few hundred angstroms. Conventional polishing techniques are largely inadequate to produce the requisite degree of planarity and global uniformity across the relatively large surfaces of wafers used to manufacture current and future integrated circuits. The compliant nature of conventional polymeric CMP pads allows the polishing pad to remove both high and low features on the wafer surface, albeit at different removal rates. In addition, the abrasives in the polishing fluid tend to accumulate in the low feature areas and undesirably increase the removal rate in these areas. Even though the removal rates from the low areas are less than the removal rates in the high areas, there is a need for the removal rates or selectivity in topography to be increased in order to create a planar wafer surface with minimal reduction in overall wafer material.

In response to the deficiencies of some CMP pad/polishing fluid systems, fixed abrasive pads have been produced. Fixed abrasive pads have abrasive material fixed in the pad matrix and are much less compliant than most polymeric polishing pads that are used in conjunction with polishing fluids. Consequently, fixed abrasive pads tend to have relatively high selectivity to topography and planarization, and also provide high planarization rates at lower pressures. However, undesirable heating or damage to the wafer often results due to friction between the wafer and the fixed abrasive polishing pad.

Accordingly, it is desirable to provide a CMP system that creates sufficiently planar wafer surfaces while minimizing the overall amount of wafer material removed during polishing. It is also desirable to provide a CMP fluid that reduces the amount of heat generated during polishing due to friction. It is further desirable to provide a CMP fluid that allows for greater selectivity to topography, and a method to produce such a fluid. Furthermore, other desirable features and characteristics of the present invention will become apparent from the subsequent detailed description and the appended claims, taken in conjunction with the accompanying drawings and the foregoing technical field and background.

### BRIEF SUMMARY

A polishing fluid, and a method of making the same, is provided for a chemical-mechanical polishing process. The polishing fluid includes a surfactant having an aliphatic structure, a buffer for maintaining the polishing fluid at a pH ranging between about 5 and about 14, and a chelating agent.

A method is also provided for polishing a workpiece surface using a chemical-mechanical polishing pad having a polishing surface. First, a polishing fluid is introduced onto the polishing surface. The polishing fluid includes the components recited above. Next, the workpiece surface is polished using the polishing surface and the polishing fluid.

An apparatus is also provided for performing a chemical-mechanical polishing process on a workpiece surface. The apparatus includes a fixed abrasive chemical-mechanical polishing pad having a polishing surface, a workpiece carrier for securing the workpiece surface against the polishing surface during said polishing process, a polishing fluid container, the polishing fluid including the components recited above, and a polishing fluid supply channel that is in fluid communication with the container and is adapted to supply the polishing fluid to the polishing surface.

### BRIEF DESCRIPTION OF THE DRAWINGS

The present invention will hereinafter be described in conjunction with the following drawing figures, wherein like numerals denote like elements, and

FIG. 1 is a top cutaway view of a polishing system in accordance with the present invention;

FIG. 2 is a top cutaway view of a portion of an electrochemical polishing apparatus in accordance with the present invention;

FIG. 3 is a bottom cutaway view of a carousel for use with the apparatus depicted in FIG. 2;

FIG. 4 is a top plan view of a typical workpiece carrier for use in conjunction with the present invention;

FIG. 5 is a top cutaway view of apportion of an electrochemical polishing apparatus in accordance with the present invention;

FIG. 6 is a top view of a CMP pad while polishing a wafer according to an embodiment of the present invention;

FIG. 7 is a cross sectional view of the CMP pad depicted in FIG. 6;

FIG. 8 is a cross sectional view of a polished wafer after processing using a CMP fluid and a CMP method according to embodiments of the present invention.

### DETAILED DESCRIPTION

The following detailed description is merely exemplary in nature and is not intended to limit the invention or the application and uses of the invention. Furthermore, there is no intention to be bound by any expressed or implied theory presented in the preceding technical field, background, brief summary or the following detailed description.

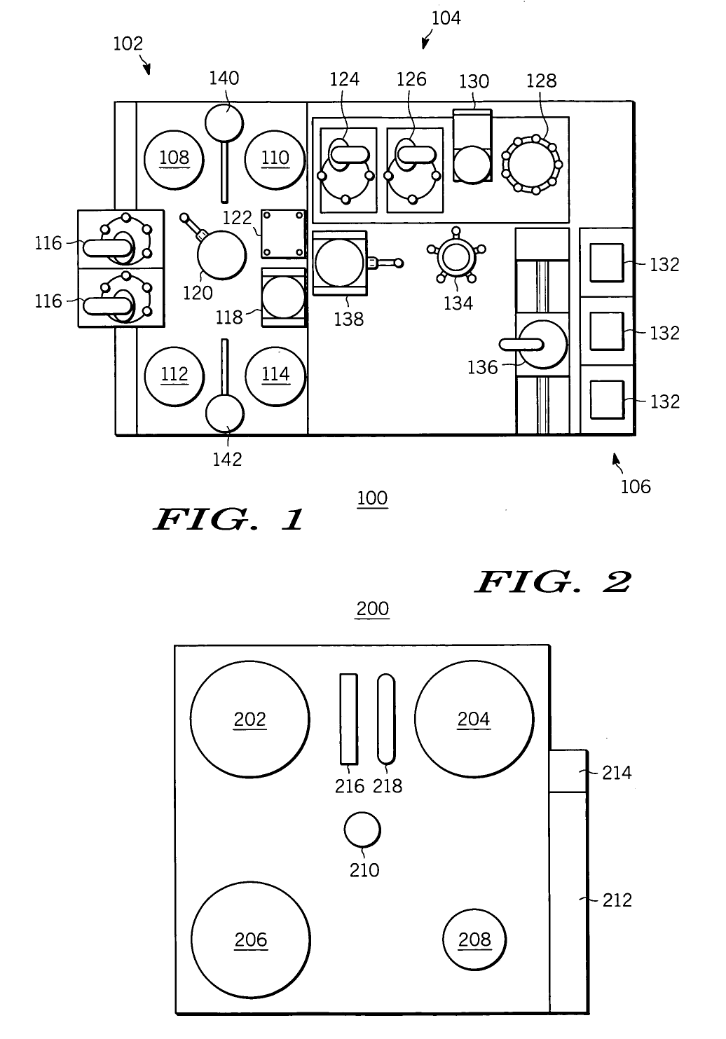

FIG. 1 illustrates a top cutaway view of a CMP polishing apparatus 100 that utilizes the CMP fluid of the present invention. The apparatus 100 depicted is suitable for polishing or planarizing material from the surface of a workpiece and can incorporate the fluid distribution system of the present invention. The apparatus 100 includes a multi-station polishing system 102, a clean system 104, and a wafer load/unload station 106. In addition, the apparatus 100 includes a cover (not shown) that surrounds the apparatus 100 to isolate the apparatus 100 from the surrounding environment. The apparatus 100 may be any machine capable of removing material from a workpiece surface using a polishing fluid together with a polishing pad.

Although the polishing fluid of the present invention may be used to remove or polish material from the surface of a variety of workpieces such as magnetic disks, optical disks, and the like, the invention is conveniently described below in connection with removing material from the surface of a wafer. In the context of the present invention, the term “wafer” shall mean semiconductor substrates, which may include layers of insulating, semiconductor, and conducting layers or features formed thereon and used to manufacture microelectronic devices.

An exemplary polishing system 102 includes four polishing stations, 108, 110, 112, and 114, that operate independently; a buff station 116; a stage 118; a robot 120; and optionally, a metrology station 122. Polishing stations 108-114 may be configured as desired to perform specific functions.

A polishing fluid container 148 that may be externally or internally associated with the polishing system 102 supplies polishing fluid to the polishing stations 108-114 through a polishing fluid supply channel 150. There are several ways in which the polishing fluid may be supplied to a workpiece surface during polishing. For instance, the polishing fluid supply channel 150 may be directed to a polishing platen for through-the-pad polishing systems, or directed to a workpiece holder for systems in which the fluid is simply applied to a workpiece surface from above the surface. Although not shown in all of the embodiments described below, each polishing system includes some type of polishing fluid container and supply channel that provides the polishing fluid to the workpiece surface.

The polishing system 102 also includes polishing surface conditioners 140 and 142. The configuration of the conditioners 140 and 142 generally depends on the type of polishing surface to be conditioned. For example, when the polishing surface comprises a polyurethane polishing pad, conditioners 140 and 142 may include a rigid substrate coated with diamond material. Various other surface conditioners may also be used in accordance with the present invention, and particularly conditioners for conditioning a fixed abrasive polishing pad.

The clean system 104 is generally configured to remove debris such as polishing fluid residue and material from the wafer surface during polishing. In accordance with the illustrated embodiment, the system 104 includes clean stations 124 and 126, a spin rinse dryer 128, and a robot 130 configured to transport the wafer between the clean stations 124 and 126 and the spin rinse dryer 128. Alternatively, the clean station 104 may be separate from the remainder of the planarization apparatus. In this case, the load station 106 is configured to receive dry wafers for processing, but the wafers may remain in a wet (e.g., deionized water) environment until the wafers are transferred to the clean station. In operation, cassettes 132, including one or more wafers, are loaded onto apparatus 100 at station 106. The wafers are then individually transported to a stage 134 using a dry robot 136. A wet robot 138 retrieves a wafer at the stage 134 and transports the wafer to metrology station 122 for film characterization or to the stage 118 within the polishing system 102. The robot 120 picks up the wafer from the metrology station 122 or the stage 118 and transports the wafer to one of the polishing stations 108-114 for wafer surface planarization. After a desired amount of material has been removed, the wafer may be transported to another polishing station.

After material has been removed from the wafer surface, the wafer is transferred to the buff station 116 to further polish the surface of the wafer. After the polishing and/or buff process, the wafer is transferred to the stage 118 which is configured to maintain one or more wafers in a wet (e.g. deionized water) environment.

After the wafer is placed on the stage 118, the robot 138 picks up the wafer and transports it to the clean system 104. In particular, the robot 138 transports the wafer to the robot 130, which in turn places the wafer in one of the clean stations 124, 126. The wafer is there cleaned and then transported to the spin rinse dryer 128 to rinse and dry the wafer prior to transporting it to the load/unload station 106 using the robot 136.

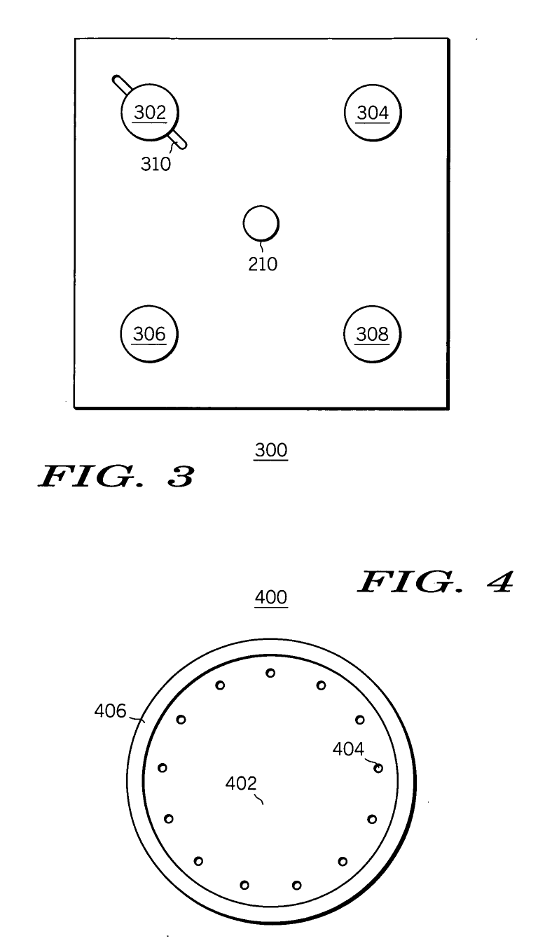

FIG. 2 illustrates a top cut away view of another exemplary polishing apparatus 200, configured to planarize a wafer using the polishing fluid of the present invention. The apparatus 200 is suitably coupled to a carousel 300 illustrated in FIG. 3 to form an automated polishing system. The system in accordance with this embodiment may also include a removable cover (not shown) overlying the apparatus 200 and the carousel 300.

The apparatus 200 includes three polishing stations, 202, 204, and 206, a wafer transfer station 208, a center rotational post 210 that is coupled to carousel 300 and which operatively engages carousel 300 to cause carousel 300 to rotate, a load and unload station 212, and a robot 214 configured to transport wafers between stations 212 and 208. Furthermore, the apparatus 200 may include one or more rinse washing stations 216 to rinse and/or wash a surface of a wafer before or after a polishing process. Although illustrated with three polishing stations, the apparatus 200 may include any desired number of polishing stations, and one or more such polishing stations may be used to buff a surface of a wafer. Furthermore, the apparatus 200 may include an integrated wafer clean and dry system similar to the system 104 described above. The wafer station 208 is generally configured to stage wafers before or between polishing and/or buff operations and may be further configured to wash and/or maintain the wafers in a wet environment.

The carousel 300 includes polishing heads, or carriers, 302, 304, 306, and 308, each configured to hold a single wafer and urge the wafer against the polishing surface (e.g., a polishing surface associated with one of stations 202-206). Each carrier 302-308 is suitably spaced from post the 210 such that each carrier aligns with a polishing station or the wafer station 208. In accordance with one embodiment of the invention, each carrier 302-308 is attached to a rotatable drive mechanism that allows the carriers 302-308 to cause a wafer to rotate (e.g., during a polishing process). In addition, the carriers may be attached to a carrier motor assembly that is configured to cause the carriers to translate as, for example, along tracks 310. Furthermore, each carrier 302-308 may rotate and translate independently of the other carriers.

In operation, wafers are processed using the apparatus 200 and carousel 300 by loading a wafer onto the station 208 from the station 212 using the robot 214. When a desired number of wafers are loaded onto the carriers, at least one of the wafers is placed in contact with the polishing surface. The wafer may be positioned by lowering a carrier to place the wafer surface in contact with the polishing surface, or a portion of the carrier (e.g., a wafer holding surface) may be lowered to position the wafer in contact with the polishing surface. After polishing is complete, one or more conditioners 218 may be employed to condition the polishing surfaces.

During a polishing process, a wafer may be held in place by a carrier 400, illustrated in FIG. 4. The carrier 400 comprises a retaining ring 406 and a receiving plate 402 including one or more apertures 404. The apertures 404 are designed to assist retention of a wafer by the carrier 400 by, for example, allowing a vacuum pressure to be applied to the backside of the wafer or by creating enough surface tension to retain the wafer. The retaining ring 406 limits the movement of the wafer during the polishing process.

FIG. 5 illustrates another polishing system 500 in accordance with the present invention. It is suitably configured to receive a wafer from a cassette 502 and return the wafer to the same or to a predetermined different location within the cassette in a clean common dry state. The system 500 includes polishing stations 504 and 506, a buff station 508, a head loading station 510, a transfer station 512, a wet robot 514, a dry robot 516, a rotatable index table 518, and a clean station 520. The dry robot 516 unloads a wafer from the cassette 502 and places the wafer on the transfer station 512. The wafer then travels to the polishing stations 504-508 for polishing and returns to the station 510 for unloading by the wet robot 514 and the transfer station 512. The wafer is then transferred to the clean system 520 to clean, rinse, and dry the wafer before the wafer is returned to the load and unload station 502 using the dry robot 516.

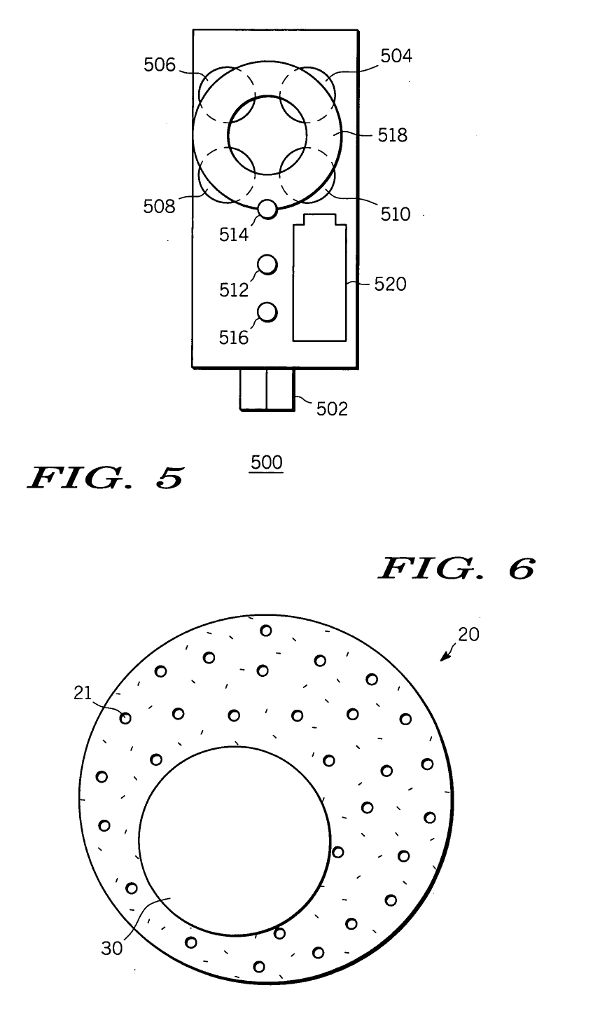

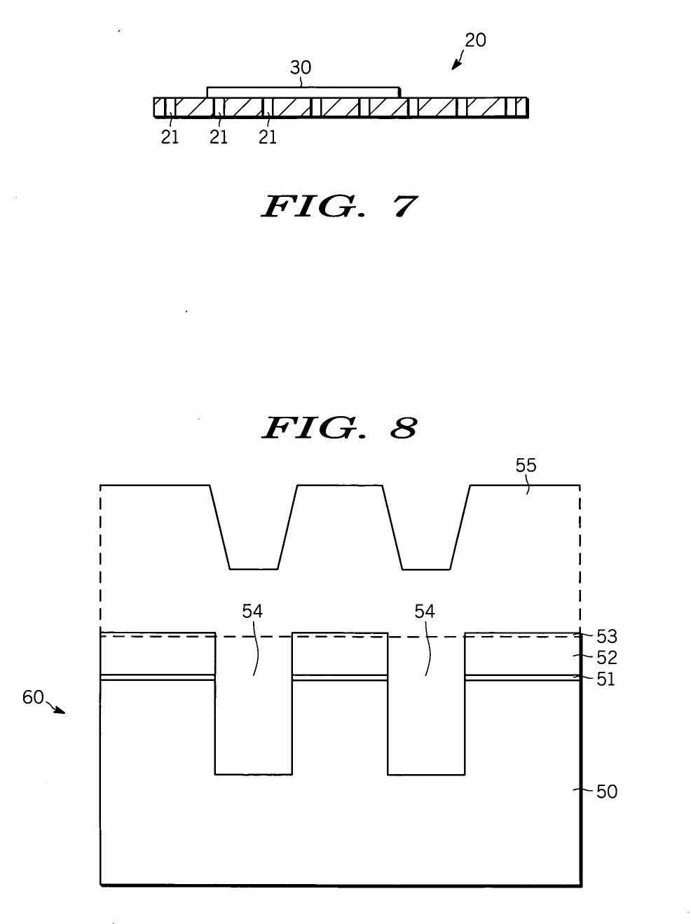

Turning now to an example of a CMP pad that may be used in conjunction with the CMP fluid of the present invention, a top view of a fixed abrasive CMP pad 20 is depicted in FIG. 6, and a cross sectional view is depicted in FIG. 7. The CMP pad 20 is typically mounted on a platen (not shown) that can be used with any of the above-described CMP tools. A wafer 30 is pressed against the CMP pad surface 22 in the presence of a fluid while relative motion between the wafer 30 and the CMP pad 20 is generated. Various combinations of motions for the wafer 30 and/or the CMP pad 20 are known. For example, the wafer 30 may be rotated or oscillated about its central axis while the polishing pad 20 may be orbited, rotated, vibrated or oscillated in a linear direction. Despite the CMP pad 20 being shown as disk-shaped, it may be manufactured to be any suitable shape.

During polishing, the CMP fluid of the present invention is introduced between the CMP pad 20 and the wafer 30 to enhance the planarization process. A plurality of through-holes 21 may be formed, preferably by drilling, through the CMP pad 20 to facilitate the transportation of CMP fluid to the wafer-CMP pad interface. Since the CMP pad is abrasive, the fluid preferably does not include abrasive particles. This advantageously prevents abrasives from the fluid to accumulate in wafer low areas. Thus, the removal rate for wafer high areas is very high during polishing, while the removal rate for wafer low areas is very low.

Grooves (not shown) may also be formed in the CMP pad surface 23 to evenly distribute the fluid about the surface 23. The grooves may be created with various characteristics in terms of width, depth, shape, direction, or concentration in a given area of the surface 23. The grooves may be formed during the curing process using a mold, or formed after the curing process by removing material on the CMP pad surface 23 by cutting or grinding, for example.

The CMP pad 20 includes an abrasive material uniformly distributed in a cured binder resin. The abrasive material may be, for example, ceria, alumina, or silica. An example of a suitable resin is a liquid epichlorohydrin based epoxy resin that is cured using a curing agent. The epoxy resin may be a modified bisphenol sold under the trade name of EPON® Resin 813, Shell code 43214. The curing agent may be an aromatic diamine sold under the trade name EPI-Cure®, Shell code 44612. In an exemplary embodiment of the invention, the amount of resin used is between about 5% and about 15% by weight of the filler material, and the amount of epoxy curing agent used is between about 10% and about 30% by weight of the resin material.

In an exemplary embodiment of the invention, the abrasive is distributed in a matrix that includes a soft friable filler material, and preferably a resin-coated filler material. When the soft filler material is friable, new abrasive material is allowed to be exposed as the planarization process progresses and as the CMP pad 20 wears.

Exemplary materials for the filler material include, but are not limited to minerals such as talc, gypsum, and calcite, and the friable material preferably has a hardness less than 3 on the Mohs hardness scale. The filler prevents scratches or formation of other contact related defects on the wafer 30, particularly when processed to be of a suitable size and hardness. In an exemplary embodiment of the invention, the filler material has a particle size ranging between about 50 and about 1000 mesh, and preferably between about 200 and about 325 mesh.

One exemplary method for producing the CMP pad 20 will now be described. A filler material as described above is placed in a mixer. The filler material may be sieved by a mesh to obtain the desired range of particle sizes. In an exemplary method, the filler material includes talc of a particle size ranging between about 200 and about 325 mesh. Next, a binder and solvent are thoroughly mixed together. The binder includes an epoxy resin and a curing agent in an exemplary embodiment. The resin and curing agent are mixed with a solvent such as acetone or another suitable solvent suitable for wetting all of the filler material. In an exemplary embodiment, the solvent is acetone and is added at an amount such that the volume of the combined binder and solvent will be about 500 ml for each 650 g of filler.

The binder and solvent mixture are added to the filler material and thoroughly mixed to create a resin-coated filler material. The binder and solvent may be slowly poured into the mixer with the filler and slowly, but thoroughly, mixed together. The resin coated filler material will achieve a dough-like consistency which should be kneaded until no free liquid is visibly apparent and the resin coated filler material stops sticking to the mixing bowl.

After coating the filler, the resin-coated filler material is dried. The drying time may be shortened by spreading the resin coated filler material into a thin layer, thereby exposing more of the resin-coated filler material surface area. In addition, the resin-coated filler material may be crushed or broken into smaller pieces to further enhance the drying process. At 70° F. sufficient amount in quantity to form a single polishing pad may be dried in about 24 hours. Excessive drying is preferably avoided as the subsequent grinding process may be very difficult to perform on a hardened resin-coated filler material.

The resin-coated filler material may be broken into particles having a predetermined range of particle sizes. A grinding mill with high speed rotating blades, or any other known method of breaking a hard material into particles of a desired size may be used to grind the resin-coated filler material. The resin-coated filler material may also be sieved to obtain the desired range of particle sizes. For example, the resin-coated filler material may be sieved to obtain particle sizes of about 35 to about 200 mesh, preferably about 100 mesh.

Next, an abrasive material of known mesh size and purity are added to the resin-coated filler material. The abrasive particles may be sized according to need, and an exemplary particle size ranges from sub-micron to about 5 microns. The weight ratio of abrasive to resin-coated filler material may be between about 0.3 and about 0.7. Again, the chosen abrasive, particle size, and the weight ratio of abrasive/resin-coated filler material may be specifically optimized depending on the desired polishing characteristics, such as removal rate, of the CMP pad, and the particular characteristics of the wafer to be polished. The mixture of resin-coated filler material and abrasive material may be further sieved to thoroughly mix and uniformly distribute the abrasive material throughout the resin-coated filler material. The sieving process removes particles that have agglomerated to an undesirably large size, and may be repeated to ensure that all the particles are thoroughly mixed and form a powder material.

The pad may be molded by transferring the powder material to a mold of sufficient strength to withstand the later compressing step without excessive warping to ensure the polishing pad has a sufficiently planar working surface. The mold shape may be adapted to form a polishing pad shape as desired, although cutting or grinding may be necessary in addition to molding. The mold inner surfaces may need to be coated with a releasing agent or covered with release paper to facilitate removal of the material from the mold. An exemplary release agent is Ease Release 500 manufactured by Mann Formulated, Inc. If the mold is sized to be filled to the top, the amount of powder material may be controlled by placing excess powder in the mold and then dragging a flat bar across the top of the mold to remove the excess. For example, the mold may be disc shaped with a fixed top plate and a movable bottom push plate. The top plate and push plate surfaces may have release paper covering them while a concave inner wall is coated with a releasing agent. Pins may be created in either the top plate or bottom push plate surfaces and extend to corresponding receiving apertures in the opposing plate for creating conduits through the finished CMP pad. Alternatively, the conduits may be drilled into the cured polishing pad. In another example, grooves may be formed on the CMP pad working surface by providing a raised set of ribs on either the top plate or the bottom push plate that will form corresponding grooves in the CMP pad.

The powder material is then compressed within the mold. Compression may be accomplished by transferring the mold to a hydraulic press. Initial short duration and low down force compressions may be used to allow air to be released and uniform powder material compaction. As a specific example, four compressions at five tons for 10 seconds may be applied. Thereafter, longer duration and higher down force compressions may be applied to fully compact the powder material. As a specific example, a first compression at 40 tons for 15 minutes is followed by a second compression at 45 tons for 20 minutes. The number of total compressions and applied down force, and the length of time for each compression may be varied to achieve different polishing pad characteristics such as polishing quality, polishing pad life, abrasive release characteristics, planarization efficiency, selectivity to topography, micro-scratching, and initial and final removal rates for the particular wafer being processed.

Next, the powder material in the mold is cured. Curing may be accomplished, for example, by heating the powder material in an oven. As a specific example, an oven is preheated to a temperature between about 100° C. and about 200° C., preferably about 150° C. The mold is placed in the oven with a 20 kg weight over the push plate of a 300 mm diameter mold to maintain a small amount of compression on the powder material. The mold is left in the oven for about one hour and then allowed to sit in the oven for an additional two hours as the oven cools. Alternatively, the powder may be heat cured while under the full compression load. The mold is clamped or bolted together while under a load of a hydraulic press to maintain the compression load when the mold is removed from the press. The compressed assembly may then be heat cured as previously described. Some presses include an integrated heater, in which case the clamps would be unnecessary and the mold could be heat cured while in the press. After heating, the mold should be cooled at ambient temperature, and cooling may take an additional hour or longer.

The cured powder material can be removed from the mold once the powder has cooled, preferably to a temperature at or below about 60° C. Depending on the type of mold used, a push stand or other method may be used to release the cured powder material from the mold. The cured powder material can then be prepared for use as a CMP pad with a CMP tool. Conduits may be formed at this point of the process if not previously formed. Prior to forming conduits, one side of the pad may be prepared for attachment to a platen. For example, 10 ml of EPON® 13 resin may be applied to one side of the cured powder material and allowed to dry, and an adhesive tape may be applied over the resin-treated surface. Conduits may then be drilled through the cured powder material as part of a fluid delivery system.

The CMP pad may be subjected to additional treatments, including the addition of components such as windows or plugs. The windows may be formed of a suitable polymer material for facilitating optical inspection of the workpiece from beneath the pad and platen. One such suitable window is described in U.S. application Ser. No. 09/587,593, which is hereby incorporated by reference. The window may be cast or bonded directly into a conduit previously formed in the CMP pad. Alternatively, a pre-cast window may be mounted within the mold to extend from either the top plate or bottom push plate surfaces to receive apertures in the opposing plate. In the latter case, it may be necessary to coat the pre-cast window with a suitable adhesive to enhance bonding of the window to the pad material. The CMP pad may be conditioned using conventional conditioning techniques prior to pressing and planarizing a wafer. Such techniques may include the use of an abrasive, a diamond grit coated pad, or a bristle brush type pad conditioner.

It is to be understood that the CMP pad described above is only one of many that can be used with the CMP fluid of the present invention or in a CMP assembly of the present invention. It is also to be understood that the CMP fluid of the present invention may be used with any suitable abrasive CMP pad that is attached to a rigid platen as part of a polishing tool for use in planarizing a wafer.

Next, the CMP fluid according to the present invention for use in conjunction with a fixed abrasive CMP pad will be described. An essential component of the CMP fluid of the present invention is a high molecular weight surfactant that is uniformly distributed throughout the fluid. The high molecular weight surfactant serves several purposes. The surfactant is a lubricating agent and reduces the amount of heat causing friction at the wafer/CMP pad interface during polishing. The surfactant also reduces a dishing effect, which is the result of over-polishing in particular high friction areas of the wafer surface. Examples of a high molecular weight surfactant include, but are not limited to, poly(acrylic acid) potassium salts, poly(acrylic acid) salts including those having the formula [—CH₂CH(CO₂R)]ₙ wherein R═H, K⁺, or NH₄⁺ with a molecular weight between about 2000 and about 240,000, anionic fluorinated surfactants such as (R_{f}CH₂CH₂O)ₓPO(O⁻NH₄⁺)_{y} such that x+y=3 and R_{f}═CF₃CF₂(CF₂CF₂)ₙ, n=2 to 4, neutral surfactants such as C₆F₁₃CH₂CH₂SO₃H, cationic surfactants such as C₆F₁₃CH₂CH₂SO₃NH₄⁺, amphoteric surfactants, polyethylene glycol, lauric acid, stearic acid, alkali stearates, alkali laureates, oleic acid, and alkali oleate.

In an exemplary embodiment of the invention at least one buffering agent and at least one chelating agent are added. The buffering agent is included to ensure that there are no localized pH changes at the CMP pad/wafer interface, and preferably has a pH ranging between about 5 and about 14 and maintains such a range during polishing. Examples of a buffering agent include, but are not limited to, potassium carbonate, potassium phosphate, potassium sulfate, anunonium carbonate, ammonium phosphate, and ammonium sulfate. The chelating agent is beneficial for expeditiously evacuating material that is removed from the wafer surface during polishing. Examples of a chelating agent include, but are not limited to oxalic acid, ethylenediaminetetraacetic acid tripotassium salt, and potassium oxalate.

According to an exemplary embodiment of the invention, the CMP fluid is an aqueous solution that includes the above described surfactant, buffering agent, and chelating agent. The high molecular weight surfactant is included at a concentration ranging between about 0.01 vol. % and about 10 vol. %. The buffering agent is included at a concentration ranging between about 0.1 wt. % and about 20 wt. %. The chelating agent is included at a concentration ranging between about 0.1 wt. % and about 20 wt. %.

To determine the effectiveness of the CMP fluid of the present invention in comparison with other existing CMP fluids, a plasma enhanced tetraethylorthosilicate (PETEOS) film was removed from wafers having substantially identical wafers. A cross sectional view of the polished wafer 60 is depicted in FIG. 8. Selectivity to silicon nitride and dishing values in oxide trenches were measured after polishing, and the results for each polishing fluid were compared. As illustrated by the discontinuous line, a PETEOS film 55 was removed from the wafer 60 and an underlying silicon nitride layer 52 was planarized in a single CMP step. The PETEOS film 55 had a thickness of about 8000 Å above the approximately 1400 Å underlying silicon nitride layer 52. Discontinuous lines in FIG. 8 illustrate the wafer material that was removed after polishing. The PETEOS film 55 also filled previously formed trenches 54 that were previously formed. The trenches 54 extended about 5000 Å into a base Si layer 50, and through the silicon nitride layer 52 and an approximately 150 Å intermediate oxide layer 51.

Following removal of the PETEOS film 55 and planarization of the silicon nitride layer 52 using a fixed abrasive CMP pad and a CMP fluid produced using the compositions and methods set forth above, measurements were taken for the thickness of the remaining silicon nitride layer 52 and the amount of oxide removed from the trenches 54. The amount of silicon nitride removed from the planarized wafers was about 50 Å, leaving an average of about 1400 A of silicon nitride on the wafers. In other words, after all of the PETEOS film was completely removed from the wafers, the wafers were substantially planar after removing an average of about 50 Å of silicon nitride, the thickness of which is referenced with numeral 53 in FIG. 8. Even though the tested wafers had different trench concentrations, and consequently had different polishing surface densities, the amounts of silicon nitride removed from each wafer after polishing were not significantly different. Further, the wafers polished with the CMP fluid of the present invention revealed a remarkably small dishing effect, as the polishing removed an average of about 700 Å of oxide from the trenches formed in the wafer surfaces.

In comparison, three conventional CMP pad/fluid combinations were tested for planarizing wafers of different polishing surface densities. Like the tests above, a layer of PETEOS of approximately 8000 Å was removed from a variety of wafers, and the wafers continued to be polished thereafter until the polished surfaces were substantially planar. Between about 270 Å and about 1200 Å of silicon nitride was removed from wafers having between 30% and 90% polishing surface density, and between about 450 Å and about 1175 Å of silicon nitride was removed from wafers having between 20% and 90% polishing surface density. Also, the dishing effect was substantially more pronounced for most of the conventional CMP fluid/pad combinations. It is thought that the novel high molecular weight surfactant in the polishing fluid of the present invention reduces the dishing effect, as the large molecules prevent the fixed abrasive particles from eroding the oxide in the trenches during polishing.

From these results it is clear that the CMP fluid of the present invention provides higher selectivity and overall consistency than the tested conventional CMP slurries when used for polishing wafers with a fixed abrasive CMP pad. While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing the exemplary embodiment or exemplary embodiments. It should be understood that various changes can be made in the function and arrangement of elements without departing from the scope of the invention as set forth in the appended claims and the legal equivalents thereof.

1. A polishing fluid for a chemical-mechanical polishing process, comprising:
a surfactant having an aliphatic structure;
a buffer for maintaining said polishing fluid at a pH ranging between about 5 and about 14; and
a chelating agent.

2. The polishing fluid according to claim 1, wherein said surfactant is included at a concentration ranging between about 0.01 vol. % and about 10 vol. %

3. The polishing fluid according to claim 1, wherein said surfactant includes one or more compounds selected from the group consisting of poly(acrylic acid) potassium salts, poly(acrylic acid) ammonium salts, anionic fluorinated surfactants, neutral fluorinated surfactants, cationic fluorinated surfactants, amphoteric fluorinated surfactants, polyethylene glycol, lauric acid, stearic acid, alkali stearates, alkali laureates, oleic acid, and alkali oleate.

4. The polishing fluid according to claim 1, wherein said chelating agent includes one or more compounds selected from the group consisting of oxalic acid, ethylenediaminetetraacetic acid tripotassium salt, and potassium oxalate.

5. The polishing fluid according to claim 1, wherein said chelating agent is included at a concentration ranging between about 0.1 wt. % and about 20 wt. %.

6. The polishing fluid according to claim 1, wherein said buffer maintains said polishing fluid at a pH of about 7.

7. A method for making a polishing fluid, comprising the step of:
combining a surfactant having an aliphatic structure, a chelating agent, and a solvent with a buffering agent for maintaining said polishing fluid at a pH ranging between about 5 and about 14.

8. The method according to claim 7, wherein said surfactant is included at a concentration ranging between about 0.1 vol. % and about 10 vol. %

9. The method according to claim 7, wherein said surfactant includes one or more compounds selected from the group consisting of poly(acrylic acid) potassium salts, poly(acrylic acid) ammonium salts, anionic fluorinated surfactants, neutral fluorinated surfactants, cationic fluorinated surfactants, amphoteric fluorinated surfactants, polyethylene glycol, lauric acid, stearic acid, alkali stearates, alkali laureates, oleic acid, and alkali oleate.

10. The method according to claim 7, wherein said chelating agent includes one or more compounds selected from the group consisting of oxalic acid, ethylenediaminetetraacetic acid tripotassium salt, and potassium oxalate.

11. The method according to claim 7, wherein said chelating agent is included at a concentration ranging between about 0.1 wt. % and about 20 wt. %.

12. The method according to claim 7, wherein said buffering agent maintains said polishing fluid at a pH of about 7.

13. A method for polishing a workpiece surface using a chemical-mechanical polishing pad having a polishing surface, comprising the steps of:
introducing a polishing fluid onto said polishing surface, said polishing fluid comprising:
a surfactant having an aliphatic structure,
a buffer for maintaining said polishing fluid at a pH ranging between about 5 and about 14, and
a chelating agent; and
polishing said workpiece surface using said polishing surface and said polishing fluid.

14. The method according to claim 13, wherein said surfactant is included at a concentration ranging between about 0.1 vol. % and about 10 vol. %

15. The method according to claim 13, wherein said surfactant includes one or more compounds selected from the group consisting of poly(acrylic acid) potassium salts, poly(acrylic acid) ammonium salts, anionic fluorinated surfactants, neutral fluorinated surfactants, cationic fluorinated surfactants, amphoteric fluorinated surfactants, polyethylene glycol, lauric acid, stearic acid, alkali stearates, alkali laureates, oleic acid, and alkali oleate.

16. The method according to claim 13, wherein said chelating agent includes one or more compounds selected from the group consisting of oxalic acid, ethylenediaminetetraacetic acid tripotassium salt, and potassium oxalate.

17. The method according to claim 13, wherein said chelating agent is included at a concentration ranging between about 0.1 wt. % and about 20 wt. %.

18. The method according to claim 13, wherein workpiece surface includes trenches having an oxide compound formed therein, and
said polishing step planarizes said workpiece surface, said fluid preventing removal of said oxide below said planarized workpiece surface.

19. An apparatus for performing a chemical-mechanical polishing process on a workpiece surface, comprising:
a fixed abrasive chemical-mechanical polishing pad having a polishing surface;
a workpiece carrier for securing said workpiece surface against said polishing surface during said polishing process;
a polishing fluid container;
a polishing fluid disposed in said container, comprising:
a surfactant having an aliphatic structure,
buffer for maintaining said polishing fluid at a pH ranging between about 5 and about 14, and
a chelating agent; and
a polishing fluid supply channel, in fluid communication with said container, and adapted to supply said polishing fluid to said polishing surface.

20. The apparatus according to claim 19, wherein said surfactant is included at a concentration ranging between about 0.01 vol. % and about 10 vol. %

21. The apparatus according to claim 19, wherein said surfactant includes one or more compounds selected from the group consisting of poly(acrylic acid) potassium salts, poly(acrylic acid) ammonium salts, anionic fluorinated surfactants, neutral fluorinated surfactants, cationic fluorinated surfactants, amphoteric fluorinated surfactants, polyethylene glycol, lauric acid, stearic acid, alkali stearates, alkali laureates, oleic acid, and alkali oleate.

22. The apparatus according to claim 19, wherein said chelating agent includes one or more compounds selected from the group consisting of oxalic acid, ethylenediaminetetraacetic acid tripotassium salt, and potassium oxalate.

23. The apparatus according to claim 19, wherein said chelating agent is included at a concentration ranging between about 0.1 wt. % and about 20 wt. %.

24. The apparatus according to claim 19, wherein said buffer maintains said polishing fluid at a pH of about 7.

25. The apparatus according to claim 19, wherein said polishing pad comprises a substantially uniform mixture of a friable filler material, an abrasive, and a resinous binder, and is constructed to continually wear during polishing and thereby facilitate continuous exposure of the abrasive.
